(19) United States
(12) Patent Application Publication
(10) Pub. No.: US 2004/0151228 A1
(43) Pub. Date: Aug. 5, 2004

(54) Semiconductor laser device

(75) Inventor: Kazuyoshi Fuse, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/743,258

(22) Filed: Dec. 23, 2003

(30) Foreign Application Priority Data
Dec. 27, 2002 (JP) 2002-380284

(51) Int. Cl. H01S 3/08

(52) U.S. Cl. 372/101

(57) ABSTRACT

A semiconductor device is provided with a base, a semiconductor laser configured to be supported by the base, and a collimate lens configured to have a portion opposed to a light-outgoing region of the semiconductor laser and a portion to be adhered to the base. A notch a notch is formed at the base, and held between a portion to which the collimate lens is adhered and a portion which supports the semiconductor laser, of the base.

### CROSS-REFERENCE TO RELATED APPLICATIONS

This application is based upon and claims the benefit of priority from the prior Japanese Patent Application No. 2002-380284, filed Dec. 27, 2002, the entire contents of which are incorporated herein by reference.

### BACKGROUND OF THE INVENTION

1. Field of the Invention

This invention relates to an improvement of a semiconductor laser device which, in particular, can be used as a light source of a projection image display apparatus.

2. Description of the Related Art

As is well known, in recent years, extensively performed are developments of semiconductor lasers to be used as a light source in projection image display apparatuses, such as liquid crystal projectors.

In image display apparatuses of this kind, outgoing light from a semiconductor laser, which generates an intense light output as much as several to 10 W, is made incident on an optical fiber forming a fiber laser, and thereby visible light of a high optical density is generated and used for image display.

Generally, semiconductor lasers having a high output are multimode lasers, and have a light-outgoing region having an elongate shape. For example, in the light-outgoing region of a semiconductor laser which outputs 1 W, the ratio of the length of a slow axis parallel to its active layer to the length of a fast axis vertical to the active layer is 50:1 to 500:1.

In light-outgoing regions having such a high aspect ratio, light outgoing therefrom has an angle of divergence of only about ±4° in the slow axis direction with respect to an optical axis vertical to the surface of the light-outgoing region, while it has an angle of divergence of ±20° in the fast axis direction.

Therefore, in the conventional art, to make outgoing light from a semiconductor laser incident efficiently on an optical element such as an optical fiber, a collimate lens such as a rod lens and a cylindrical lens is disposed immediately in front of the light-outgoing region, and the lens converts the outgoing light, which diverges in the fast axis direction, into parallel light.

For example, Jpn. Pat. Appln. KOKAI Pub. No. 2000-98190 discloses a structure, wherein a peripheral surface in a central portion of a cylindrical rod lens is disposed adjacent to a light-outgoing surface of a semiconductor laser supported by a block member, and in the position both end portions of the peripheral surface of the rod lens are fixed on the block member by adhesive.

However, the method of attaching a rod lens disclosed in the publication has the problem that, when adhesive is provided between the block member and the peripheral surface of the rod lens, the adhesive enters between the light-outgoing surface of the semiconductor laser and the peripheral surface of the rod lens and covers the light-outgoing surface of the semiconductor laser.

### BRIEF SUMMARY OF THE INVENTION

According to one aspect of the present invention, there is provided a semiconductor laser device comprising a base, a semiconductor laser configured to be supported by the base, and a collimate lens configured to have a portion opposed to a light-outgoing region of the semiconductor laser, and a portion to be adhered to the base, wherein a notch is formed at the base, and held between a portion to which the collimate lens is adhered and a portion which supports the semiconductor laser, of the base.

### BRIEF DESCRIPTION OF THE SEVERAL VIEWS OF THE DRAWING

FIG. 1 is a perspective view illustrating a first embodiment of the present invention;

FIG. 2 is a diagram illustrating a modification of the first embodiment;

FIG. 3 is a diagram illustrating another modification of the first embodiment;

FIG. 4 is a diagram illustrating a second embodiment of the present invention;

FIG. 5 is a diagram illustrating a modification of the second embodiment; and

FIG. 6 is a diagram illustrating another modification of the second embodiment.

### DETAILED DESCRIPTION OF THE INVENTION

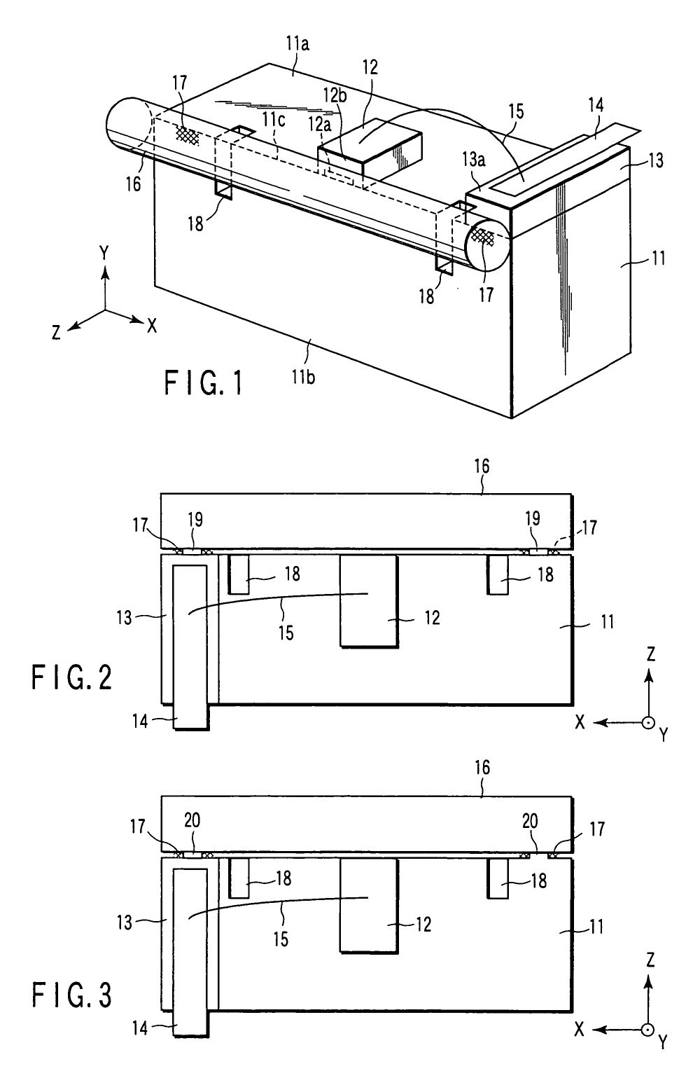

A first embodiment of the present invention will now be described in detail, with reference to drawings. FIG. 1 illustrates a schematic structure of a semi-conductor laser device explained in the first embodiment. Specifically, reference numeral 11 denotes a base, which is formed of copper and the like in a rectangular parallelpiped shape and also serves as a heat sink.

A GaAs semiconductor laser 12 is mounted in a central portion of an upper surface 11a of the base 11. The semiconductor laser 12 is supported by the base 11 such that its surface 12b having a light-outgoing region 12a is aligned with one side surface 11b of the base 11.

In the semiconductor laser 12, a direction of the slow axis of the light-outgoing region 12a is defined as an X axis, a direction of the fast axis thereof is defined as a Y axis, and a direction in which laser light outgoes from the light-outgoing region 12a, that is, a direction vertical to the surface 12b having the light-outgoing region 12a of the semiconductor laser 12 is defined as a Z axis.

Further, an insulating block 13, which is formed of ceramics and the like and is nonconductive, is mounted on an end portion of the upper surface 11a of the base 11. A terminal 14 located on an upper surface 13a of the insulating block 13 is connected to an external power supply.

The semiconductor laser 12 is connected to the external power supply, by bonding an electrode formed on an upper surface of the semiconductor laser 12 to the terminal 14 by a wire 15 formed of gold. Further, an electrode formed on another surface of the semi-conductor laser 12 facing the base 11 is also connected to the external power supply through the base 11.

The semiconductor laser 12 is mounted on the upper surface 11a of the base 11 in a junction-down manner. Therefore, the light-outgoing region 12a of the semiconductor laser 12 is set in a position directly above the upper surface 11a of the base 11 with a solder layer intervened therebetween, and aligned with the side surface 11b of the base 11.

A cylindrical rod lens 16 is located on an upper end portion of the side surface 11b of the base 11 aligned with the surface 12b having the light-outgoing region 12a of the semiconductor laser 12. The rod lens 16 is located such that its axis runs along the slow-axis direction of the light-outgoing region 12a of the semiconductor laser 12.

Further, the rod lens 16 is located such that its peripheral surface in the central portion of the rod lens is adjacent and opposed to the light-outgoing region 12a of the semiconductor laser 12. The rod lens 16 is also located such that an optical axis of laser light outgoing from the light-outgoing region 12a of the semiconductor laser 12 runs through the center of the Y-axis direction.

The rod lens 16 functions as a collimate lens for converting laser light, which outgoes from the light-outgoing region 12a of the semiconductor 12 and spreads in the fast-axis direction, into parallel light. After conversion, the laser light which has passed through the rod lens 16 is made incident on an optical element, such as an optical fiber, of the following stage.

The rod lens 16 is fixed to the base 11, by adhering both end portions of the peripheral surface to upper end portions of the side surface 11b aligned with the surface 12b having the light-outgoing region 12a of the semiconductor laser 12, by ultraviolet-setting adhesive 17.

In this case, the rod lens 16 is positioned as described above with respect to the light-outgoing region 12a of the semiconductor laser 12. Thereafter, an ultraviolet-setting adhesive 17 is poured between the both end portions of the peripheral surface and the side surface 11b of the base 11 and sets by ultraviolet irradiation. Thereby, the rod lens 16 is fixed to the base 11.

More practically speaking, the rod lens 16 is fixed by the adhesive 17 to a portion of the side surface 11b of the base 11 aligned with the surface 12b having the light-outgoing region 12a of the semiconductor laser 12. The portion of the side surface 11b is very close to an edge 11c made by the upper surface 11a, on which the semiconductor laser 12 is mounted, and the side surface 11b.

A space between the light-outgoing region 12a of the semiconductor laser 12 and the central portion of the peripheral surface of the rod lens 16 is set very narrow. Therefore, there is a risk that the adhesive 17 poured between the both end portions of the peripheral surface of the rod lens 16 and the side surface 11b of the base 11 enters between the side surface 11b and the rod lens 16 by a capillary phenomenon, and intrudes into the light-outgoing region 12a of the semiconductor laser 12.

Therefore, in the first embodiment, in the base 11, notches 18 are formed on both sides of the portion on which the semiconductor laser 12 is mounted, and inside the portions to which the adhesive 17 is applied. Each of the notches 18 are formed to range from the upper surface 11a and the side surface 11b, including the edge 11c of the base 11.

Thereby, even if the adhesive 17 poured between the end portions of the peripheral surface of the rod lens 16 and the side surface 11b of the base 11 runs between the side surface 11b and the rod lens 16, the adhesive 17 is collected in the notches 18 and is fully prevented from reaching the semiconductor laser 12. This eliminates the need to strictly specify the applying amount of the adhesive 17, thus simplifies assembly of the device.

FIG. 2 illustrates a modification of the first embodiment. Specifically, between the side surface 11b of the base 11 aligned with the surface 12b having the light-outgoing region 12a of the semiconductor laser 12 and the both end portions of the peripheral surface of the rod lens 16, spacers 19 are provided to the base 11 for controlling the space between them.

Further, the rod lens 16 is abut against the side surface 11b of the base 11 with the spacers 19 intervened therebetween, and the adhesive 17 is applied in the above state to fix the spacers 19 and the rod lens 16 to the base 11. Thereby, it is possible to easily set the space between the light-outgoing region 12a of the semiconductor laser 12 and the rod lens 16, and simplify assembly of the device.

Although the spacers 19 are provided in positions outside the notches 18 in FIG. 2, the spacers 19 may be provided in positions inside the notches 18, as long as the adhesive 17 is applied to positions outside the notches 18.

FIG. 3 illustrates another modification of the first embodiment. Specifically, in the base 11, projections 20 serving as spacers for controlling the space between the side surface 11b and the both end portions of the peripheral surfaces of the rod lens 16 are provided on the side surface 11b aligned with the surface 12b having the light-outgoing region 12a of the semiconductor laser 12.

Further, the rod lens 16 is abut against the projections 20 formed on the side surfaces 11b of the base 11, and the adhesive 17 is applied in the above state to fix the rod lens 16 to the base 11. Thereby, it is possible to easily set the space between the light-outgoing region 12a of the semiconductor laser 12 and the rod lens 16, and simplify assembly of the device.

Although the projections 20 are provided in positions outside the notches 18 in FIG. 3, the projections 20 may be provided in positions inside the notches 18, as long as the adhesive 17 is applied to positions outside the notches 18.

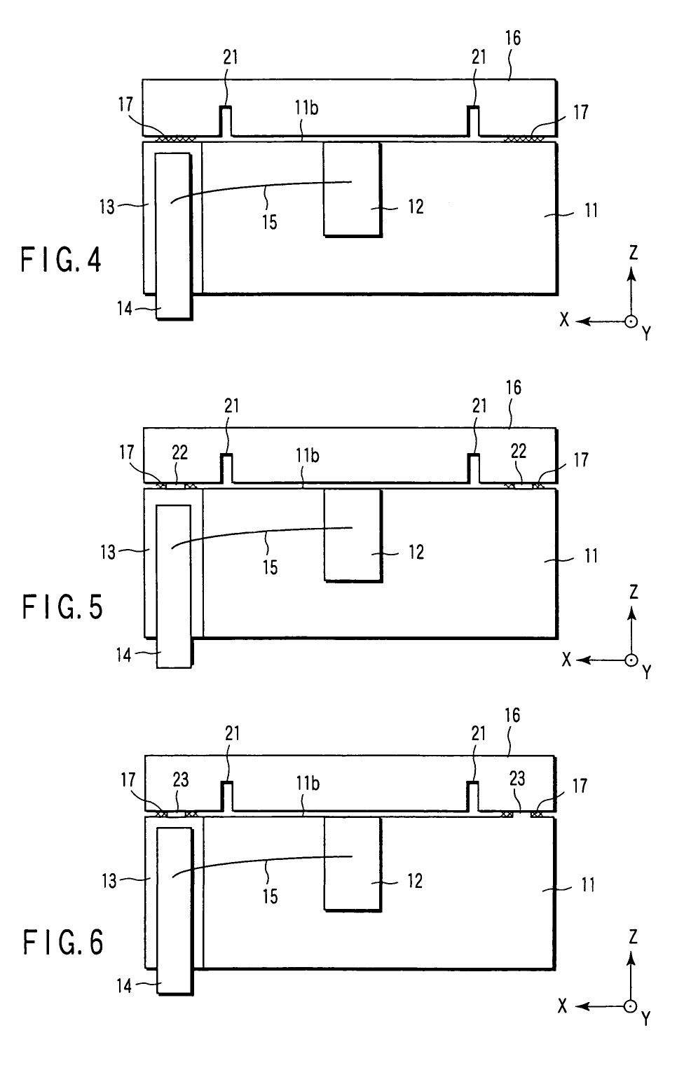

Next, FIG. 4 illustrates a second embodiment of the present invention. In FIG. 4, like reference numerals denote like constituent elements of FIG. 1. In FIG. 4, in a rod lens 16, notches 21 are formed on both sides of a portion of a peripheral surface which is opposed to a light-outgoing region 12a of a semiconductor laser 12, and at positions inside portions to which adhesive 17 is applied.

Thereby, even if the adhesive 17 poured between the both end portions of the peripheral surface of the rod lens 16 and a side surface 11b of a base 11 runs between the side surface 11b and the rod lens 16, the adhesive is collected in the notches 21 and is fully prevented from reaching the semiconductor laser 12. Therefore, it eliminates the need to strictly specify the applying amount of the adhesive 17, thus simplifies assembly of the device.

FIG. 5 illustrates a modification of the second embodiment. Specifically, in the base 11, between the side surface 11b of the base 11 aligned with the surface 12b having the light-outgoing region 12a of the semiconductor laser 12 and both end portions of the peripheral surface of the rod lens 16, spacers 22 are provided for controlling the space between them.

Further, the rod lens 16 is abut against the side surface 11b of the base 11 with the spacers 22 intervened therebetween, and the adhesive 17 is applied in the above state to fix the spacers 22 and the rod lens 16 to the base 11. Thereby, it is possible to easily set the space between the light-outgoing region 12a of the semiconductor laser 12 and the rod lens 16, and simplify assembly of the device.

Although the spacers 22 are provided in positions outside the notches 18 in FIG. 5, the spacers 22 may be provided in positions inside the notches 21, as long as the adhesive 17 is applied to positions outside the notches 21.

FIG. 6 illustrates another modification of the second embodiment. Specifically, in the base 11, projections 23 serving as spacers for controlling the space between the side surface 11b and the both end portions of the peripheral surfaces of the rod lens 16 are provided on the side surface 11b aligned with the surface 12b having the light-outgoing region 12a of the semiconductor laser 12.

Further, the rod lens 16 is abut against the projections 23 formed on the side surfaces 11b of the base 11, and the adhesive 17 is applied in the above state to fix the rod lens 16 to the base 11. Thereby, it is possible to easily set the space between the light-outgoing region 12a of the semiconductor laser 12 and the rod lens 16, and simplify assembly of the device.

Although the projections 23 are provided in positions outside the notches 21 in FIG. 6, the projections 23 may be provided in positions inside the notches 21, as long as the adhesive 17 is applied to positions outside the notches 21.

Although the case where the rod lens 16 is fixed to the base 11 is explained in the above first and second embodiments, the present invention is not limited to using the rod lens 16, but may use a cylindrical lens and the like. In short, the present invention is widely applicable to attachment of a collimate lens for converting laser light, which outgoes from the light-outgoing region 12a of the semiconductor laser 12, spreading in the fast-axis direction, into parallel light.

Further, in the first and second embodiments, the notches 18 of the base 11 and the notches 21 of the rod lens 16, respectively, are formed on both sides of the semiconductor laser 12. However, they may be formed on only one side of the semiconductor laser 12, according to necessity.

The present invention is not limited to the above embodiments, but its constituent elements may be variously modified in carrying out the present invention, without departing from the gist of the invention. Further, various inventions can be made by properly combining the plural constituent elements disclosed in the above embodiments. For example, some of the constituent elements disclosed in the embodiments may be deleted, and some of the constituent elements disclosed in one embodiment may be added to another embodiment.

What is claimed is:

1. A semiconductor laser device comprising:
a base;
a semiconductor laser configured to be supported by the base; and
a collimate lens configured to have a portion opposed to a light-outgoing region of the semiconductor laser, and a portion to be adhered to the base,
wherein a notch is formed at the base, and held between a portion to which the collimate lens is adhered and a portion which supports the semiconductor laser, of the base.

2. A semiconductor laser device according to claim 1, wherein
in the base, the notch is formed on each side of the portion which supports the semiconductor laser, and the collimate lens is adhered to portions of the base opposite to the portion which supports the semiconductor laser, with the respective notches intervened therebetween.

3. A semiconductor laser device according to claim 1, further comprising:
a spacer configured to intervene between the base and the collimate lens and define a space between the light-outgoing region of the semiconductor laser and the collimate lens.

4. A semiconductor laser device according to claim 1, wherein
a projection, which defines a space between the light-outgoing region of the semiconductor laser and the collimate lens, is formed on the base.

5. A semiconductor laser device according to claim 1, wherein
the collimate lens is formed in a cylindrical shape, a central portion of a peripheral surface of the collimate lens is opposed to the light-outgoing region of the semiconductor laser, and both end portions of the peripheral surface of the collimate lens are adhered to the base.

6. A semiconductor laser device according to claim 1, wherein
the base has a first surface on which the semiconductor laser is mounted, and a second surface which connects with the first surface and is aligned with a surface of the semiconductor laser, the surface having the light-outgoing region, and
the collimate lens is adhered to a portion of the second surface of the base, the portion is close to an edge made by the first surface and the second surface.

7. A semiconductor laser device comprising:
a base;
a semiconductor laser configured to be supported by the base;
a collimate lens configured to have a portion opposed to a light-outgoing region of the semiconductor laser, and a portion to be adhered to the base,
wherein a notch is formed at the collimate lens, the notch held between the portion opposed to the light-outgoing region of the semiconductor laser and the portion to be adhered to the base.

8. A semiconductor laser device according to claim 7, wherein
in the collimate lens, the notch is formed on each side of the portion opposed to the light-outgoing region of the semiconductor laser, and the collimate lens is adhered to the base at portions of the collimate lens, the portions located opposite to the semiconductor laser, with the respective notches intervened therebetween.

9. A semiconductor laser device according to claim 7, further comprising:
a spacer configured to intervene between the base and the collimate lens and define a space between the light-outgoing region of the semiconductor laser and the collimate lens.

10. A semiconductor laser device according to claim 7, wherein
a projection, which defines a space between the light-outgoing region of the semiconductor laser and the collimate lens, is formed on the base.

11. A semiconductor laser device according to claim 7, wherein
the collimate lens is formed in a cylindrical shape, a central portion of a peripheral surface of the collimate lens is opposed to the light-outgoing region of the semiconductor laser, and both end portions of the peripheral surface of the collimate lens are adhered to the base.

12. A semiconductor laser device according to claim 7, wherein
the base has a first surface on which the semiconductor laser is mounted, and a second surface which connects with the first surface and is aligned with a surface of the semiconductor laser, the surface having the light-outgoing region, and
the collimate lens is adhered to a portion of the second surface of the base, the portion is close to an edge made by the first surface and the second surface.
